(19) United States
(12) Patent Application Publication
(10) Pub. No.: US 2024/0119040 A1
(43) Pub. Date: Apr. 11, 2024

(54) PRESERVING CONCURRENCY AND ASYNCHRONOUS EXECUTION FOR VERSIONED DOCUMENTS

(71) Applicant: International Business Machines Corporation, Armonk, NY (US)

(72) Inventors: Varun Ojha, Panchkula (IN); Ana C. Biazetti, Cary, NC (US); Ritesh Tandon, Bangalore (IN)

(21) Appl. No.: 17/963,984

(22) Filed: Oct. 11, 2022

(51) Int. Cl. G06F 16/23; G06F 16/27

(52) U.S. Cl. CPC G06F 16/2329; G06F 16/273

(57) ABSTRACT

A computer-implemented method, system and computer program product for preserving concurrency and asynchronous execution for versioned documents. A versioned document is received to be uploaded onto a platform, such as a blockchain platform, where the metadata of the versioned document includes a first identifier representing a time at which the version of the versioned document came into existence. Furthermore, a second identifier is generated representing a specific state or instance of the versioned document with no relation to a logical order of the instance of the versioned document with respect to other versions of the versioned document. A document record may then be created for the versioned document which includes both identifiers. Such identifiers may be utilized by a distributed application, such as a blockchain application, to handle various types of requests from the users of the client devices while still preserving concurrency and asynchronous execution for versioned documents.

### TECHNICAL FIELD

The present disclosure relates generally to distributed applications, and more particularly to preserving concurrency and asynchronous execution for versioned documents uploaded to distributed applications.

### BACKGROUND

Distributed applications are applications or software that run on multiple computers within a network at the same time and can be stored on servers or cloud computing platforms. Unlike traditional applications that run on a single system, distributed applications run on multiple systems simultaneously.

### SUMMARY

In one embodiment of the present disclosure, a computer-implemented method for preserving concurrency and asynchronous execution for versioned documents comprises receiving a versioned document to be uploaded onto a platform, where metadata of the versioned document comprises a first identifier representing a time at which a version of the versioned document came into existence. The method further comprises generating a second identifier that represents a specific state or instance of the versioned document with no relation to a logical order of the instance of the versioned document with respect to other versions of the versioned document. The method additionally comprises creating a document record comprising the first identifier and the second identifier. Furthermore, the method comprises storing the document record in a distributed ledger of the platform.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the target system used for preserving concurrency and asynchronous execution for versioned documents in accordance with an embodiment of the present disclosure;

FIG. 3 illustrates an embodiment of the present disclosure of the hardware configuration of the target system which is representative of a hardware environment for practicing the present disclosure;

FIG. 4 is a flowchart of a method for uploading a document onto the blockchain platform in accordance with an embodiment of the present disclosure;

FIG. 5 illustrates uploading a document onto the blockchain platform using the steps described in FIG. 4 in accordance with an embodiment of the present disclosure;

FIG. 6 is a flowchart of a method for handling a request to retrieve all versions of a versioned document in accordance with an embodiment of the present disclosure;

FIG. 7 illustrates handling a request to retrieve all versions of a versioned document using the steps described in FIG. 6 in accordance with an embodiment of the present disclosure;

FIG. 8 is a flowchart of a method for handling a request to retrieve the latest version of a versioned document in accordance with an embodiment of the present disclosure;

FIG. 9 illustrates handling a request to retrieve the latest version of a versioned document using the steps described in FIG. 8 in accordance with an embodiment of the present disclosure;

FIG. 10 is a flowchart of a method for handling a request to retrieve a user-specified version of a versioned document in accordance with an embodiment of the present disclosure;

FIG. 11 illustrates handling a request to retrieve a user-specified version of a versioned document using the steps described in FIG. 10 in accordance with an embodiment of the present disclosure;

FIG. 12 is a flowchart of a method for handling a request to retrieve a versioned document, where the request includes the document instance identifier, in accordance with an embodiment of the present disclosure;

FIG. 13 illustrates handling a request to retrieve a versioned document, where the request includes the document instance identifier, using the steps described in FIG. 12 in accordance with an embodiment of the present disclosure;

FIG. 14 is a flowchart of a method for handling a request to retrieve a versioned document, where the request includes the document instance identifier and a hash value, in accordance with an embodiment of the present disclosure;

FIG. 15 illustrates handling a request to retrieve a versioned document, where the request includes the document instance identifier and a hash value, using the steps described in FIG. 14 in accordance with an embodiment of the present disclosure.

### DETAILED DESCRIPTION

As stated in the Background section, distributed applications are applications or software that run on multiple computers within a network at the same time and can be stored on servers or cloud computing platforms. Unlike traditional applications that run on a single system, distributed applications run on multiple systems simultaneously.

Distributed applications run on distributed computing systems, which are a collection of independent computers that appear to the user as a single system. Computers in a distributed system operate concurrently and fail independently. Furthermore, such computers operate in an asynchronous manner (no synchronization between their internal clocks). In addition to networks or cloud platforms, many distributed applications are also built and deployed on blockchain-based platforms.

Distributed applications can communicate with multiple servers or devices on the same network from any geographical location. The distributed nature of the applications refers to data being spread out over more than one computer in a network.

One example of a distributed application is an e-commerce platform that distributes different functions of the application to different computers in its network. The servers or computers host different functions, such as the following: accept payment from customers at checkout, update the customer list with new registrations, answer customer questions using a chatbot, accept product reviews from customers, analyze customer history for targeted advertising, etc. Other examples of distributed applications include banking applications, stock exchange applications, web browsers, streaming services, rideshare applications, food delivery applications, massively multiplayer online games, etc.

In recent years, distributed applications have been built and deployed on blockchain-based platforms. A blockchain is a distributed database that is supported by and shared among multiple nodes in a computer network. Such a blockchain may be used for holding different types of information, such as ledger entries and records. Ethereum, for example, is a blockchain that can be used to host other types of information, including application code. Distributed applications hosted on the blockchain are known as decentralized applications.

Versioned documents in a client system may need to be uploaded to a distributed application, such as a distributed application built and deployed on a blockchain platform, that supports asynchronous processing of these documents. A versioned document refers to a document with different versions of the same document. For example, such a document may have multiple versions, such as version 1, version 2 and version 3 of the same document.

The client system may upload these documents concurrently, such as to the blockchain platform (target system) from a source system via a blockchain application programming interface (API). The target system then processes each upload request in an asynchronous manner.

For example, when clients upload multiple versions of a document concurrently to the blockchain platform (target system) from a source system via a blockchain application programming interface (API), the document versions may become reversed between the source and target systems. For example, the document versions could arrive out of order at the blockchain or secure file transfer protocol (SFTP) location (in the case where the client uploads the documents to the SFTP location). Since the blockchain API processes these document versions in an asynchronous manner, the version ordering could be broken between the client and the blockchain platform.

Furthermore, documents that fail in asynchronous processing are queued and retried. That is, a document version may be rejected resulting in the rejected document being queued and later retried. As a result, later versions of a document may appear as earlier versions on the blockchain platform if an earlier version of a document fails to be processed by the blockchain API. When the earlier version of the document is finally uploaded via a retry, the version of the document becomes the latest version of the document. As a result, the version ordering is broken between the client and the blockchain platform.

Additionally, after uploading such versioned documents, the client may later request for a specific version of the versioned document, including requesting a logical order (e.g., version 1 followed by version 2, etc.) of the document versions if requesting more than one document version. Since the version ordering is broken between the client and the blockchain platform, the client may not be able to obtain the correct document version(s).

Hence, there is not currently a means for preserving concurrency and asynchronous execution for versioned documents uploaded to distributed applications, such as in situations in which multiple versions of a versioned document are uploaded concurrently.

The embodiments of the present disclosure provide a means for preserving concurrency and asynchronous execution for versioned documents, such as in situations in which multiple versions of a versioned document are uploaded concurrently, by incorporating an identifier referred to herein as the “document instance identifier,” which represents a specific state or instance of the versioned document with no relation to a logical order of the instance of the versioned document with respect to other versions. Such an identifier is static and uniquely identifies a document revision. A further description of these and other features is provided further below.

In some embodiments of the present disclosure, the present disclosure comprises a computer-implemented method, system and computer program product for preserving concurrency and asynchronous execution for versioned documents. In one embodiment of the present disclosure, a versioned document is received to be uploaded onto a platform, such as a blockchain platform, where the metadata of the versioned document includes an identifier (“document issuance time identifier”) representing a time at which the version of the versioned document came into existence. Furthermore, an identifier (“document instance identifier”) is generated in which the document instance identifier represents a specific state or instance of the versioned document with no relation to a logical order of the instance of the versioned document with respect to other versions of the versioned document. In one embodiment, the document instance identifier corresponds to a universally unique identifier (UUID), which is a 128 bit number, composed of 16 octets and represented as 32 base-16 characters. A document record may then be created for the versioned document which includes both the document issuance time identifier and the document instance identifier. Such a document record may be stored in the distributed ledger of the blockchain platform. Such identifiers may be utilized by a distributed application, such as a blockchain application, to handle various types of requests from the users of the client devices while still preserving concurrency and asynchronous execution for versioned documents, even after multiple versions of the versioned document have been uploaded simultaneously, such as requests to retrieve all versions of the versioned document, requests to retrieve the latest version of the versioned document, requests to retrieve a specific version of the versioned document, etc. Due to the utilization of such identifiers, the version ordering is not broken between the client device and the blockchain platform. Consequently, the client device will be able to obtain the correct document version(s).

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

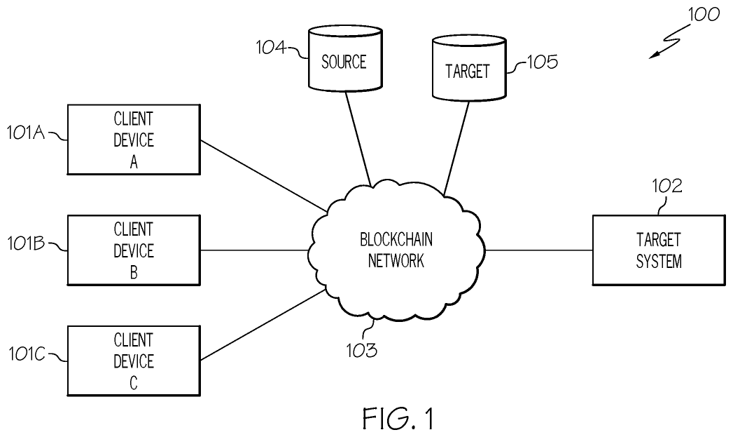

Referring now to the Figures in detail, FIG. 1 illustrates an embodiment of the present disclosure of a communication system 100 for practicing the principles of the present disclosure. Communication system 100 includes client devices 101A-101C (identified as “Client Device A,” “Client Device B,” and “Client Device C,” respectively, in FIG. 1) connected to a target system 102 via a blockchain network 103. Client devices 101A-101C may collectively or individually be referred to as client devices 101 or client device 101, respectively.

Client device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to blockchain network 103 and consequently communicating with other client devices 101 and target system 102. It is noted that both client devices 101 and the users of client devices 101 may be identified with element number 101.

In one embodiment, users of client devices 101 utilize distributed applications which are applications that run on multiple computers within a network at the same time and can be stored on other platforms, such as target system 102, including cloud computing platforms.

In one embodiment, such distributed applications are deployed on blockchain-based platforms, which is illustrated in FIG. 1 as consisting of target system 102 and storage 105 (“target storage”) connected to blockchain network 103. For example, in one embodiment, users of client devices 101 may concurrently upload multiple versions of a versioned document from database 104 (“source database”) to the blockchain platform via blockchain network 103, where such versioned documents are stored in storage 105, which may correspond to an object storage.

In one embodiment, source database 104 is connected to client device 101 via blockchain network 103. In one embodiment, source database 104 stores versioned documents created by the users of client devices 101. A “versioned document,” as used herein, refers to a document with different versions of the same document. For example, such a document may have multiple versions, such as version 1, version 2 and version 3 of the same document.

Blockchain network 103, as used herein, refers to a network that manages blockchains. In one embodiment, such a network may correspond to a peer-to-peer network. A “blockchain,” as used herein, refers to a growing list of records, called “blocks,” that are linked together using cryptography. Each block contains a cryptographic hash of the previous block, a timestamp, and transaction data. The timestamp provides that the transaction data existed when the block was published in order to get into its hash. As blocks each contain information about the block previous to it, they form a chain, with each additional block reinforcing the ones before it. Therefore, blockchains are resistant to modification of their data because once recorded, the data in any given block cannot be altered retroactivity without altering all subsequent blocks.

As discussed above, blockchains are managed by network 103, such as a peer-to-peer network. Such blockchains are managed by network 103 for use as a publicly distributed ledger, where nodes collectively adhere to a protocol to communicate and validate new blocks.

In one embodiment, blockchain network 103 includes one of the following types of blockchain networks: public blockchain network, private blockchain network, consortium blockchain network and permissioned blockchain network.

A public blockchain network is non-restrictive and permissionless, and anyone with Internet access can sign-on to a blockchain platform to become an authorized node. In a public blockchain network, information is distributed across the network, such as a peer-to-peer network. Its decentralized nature requires a method for verifying the authenticity of data.

Such a method may be a consensus algorithm whereby participants in the blockchain reach agreement on the current state of the ledger. In one embodiment, such consensus methods include proof of word and proof of stake. Furthermore, in such a public blockchain network, users can access current and past records. No valid record or transaction can be changed on the network and any one can verify the transactions.

A private blockchain network, similar to a public blockchain network, is a decentralized peer-to-peer network. However, one organization governs the network, controlling who is allowed to participate, execute a consensus protocol and maintain the shared ledger. In one embodiment, the private blockchain can be run behind a corporate firewall and be hosted on the premises.

A consortium blockchain network involves multiple organizations that share the responsibilities of maintaining a blockchain. These pre-selected organizations determine who may, submit transactions or access the data. A consortium blockchain is ideal for businesses when all participants need to be permissioned and have a shared responsibility for the blockchain.

A permissioned blockchain network refers to placing restrictions on who is allowed to participate in the network and in what transactions. Participants need to obtain an invitation or permission to join.

As discussed above, in one embodiment, distributed applications are deployed by the users of client devices 101 onto blockchain-based platforms, which is illustrated in FIG. 1 as consisting of target system 102 and storage 105 (“target storage”) connected to blockchain network 103. In one embodiment, target system 102 is configured to receive a versioned document from client device 101 to be uploaded onto a platform, such as a blockchain platform.

Additionally, in one embodiment, the metadata for the versioned document requested to be uploaded onto a platform, such as a blockchain platform, may include an identifier referred to herein as the “document instance identifier.” The document instance identifier, as used herein, refers to a static identifier that uniquely identifies a document revision. Furthermore, the document instance identifier, as used herein, represents a specific state or instance of a document that does not hold any relation to the logical order of this instance with respect to other versions of the document.

In one embodiment, upon receipt of a versioned document to be uploaded onto a platform, such as a blockchain platform, target system 102 may generate a document instance identifier for the versioned document if the versioned document does not currently have such a document instance identifier associated with it.

In one embodiment, target system 102 is configured to store a document version of the versioned document requested to be uploaded onto a platform, such as a blockchain platform. In one embodiment, such a document version of the versioned document is stored in storage 105, which may correspond to an object storage. An “object storage,” as used herein, refers to computer data storage that manages data as objects. In one embodiment, the object storage adds comprehensive metadata to the file, eliminating the tiered file structure used in file storage, and places everything into a flat address space, referred to as a storage pool. In one embodiment, the object storage takes each piece of data and designates it as an object.

Furthermore, in one embodiment, target system 102 is configured to create a document record for each versioned document uploaded to storage 105. A “document record,” as used herein, refers to a content file that has information pertaining to a versioned document that was uploaded to storage 105. For example, such a document record may include the document identifier, the document instance identifier, and the document issuance time identifier. Furthermore, in one embodiment, the document record includes a hash value, which corresponds to a unique value that corresponds to the content of the versioned document. In one embodiment, such a hash value is generated by obtaining a hash of the contents of the versioned document using a hash algorithm (e.g., MD5 (Message Digest 5) or SHA (Secure Hash Algorithm)).

Furthermore, in one embodiment, the document record includes a storage location, which corresponds to the location of the versioned document stored in storage 105, such as an object storage.

Additionally, in one embodiment, target system 102 is configured to handle various types of requests from the users of client devices 101 while still preserving concurrency and asynchronous execution for versioned documents via the use of the document issuance time identifier and the document instance identifier. Examples of such types of requests include a request to retrieve all versions of a versioned document, a request to retrieve the latest version of the versioned document, a request to retrieve a specific version of the versioned document, a request to retrieve a versioned document, where the request includes the document instance identifier, as well as a request to retrieve a versioned document, where the requests includes the document instance identifier as well as a hash value.

By utilizing such identifiers (document issuance time identifier and the document instance identifier), no document versions will be rejected and an audit trail is preserved (i.e., the version ordering will not be broken between the client and the blockchain platform). Furthermore, each document version can be identified in a deterministic fashion via the document instance identifier as discussed further below. Additionally, floating versions ensure a traditional ordered view of the document based on the document issuance time identifier as discussed further below. Furthermore, client devices 101 may implement the fire and forget integration pattern. The “fire and forget integration pattern,” as used herein, refers to an asynchronous pattern in which a message is sent from a source to a target with no attempt to track the results or response.

A more detailed description of these and other features is provided further below.

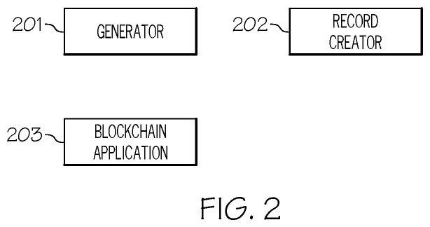

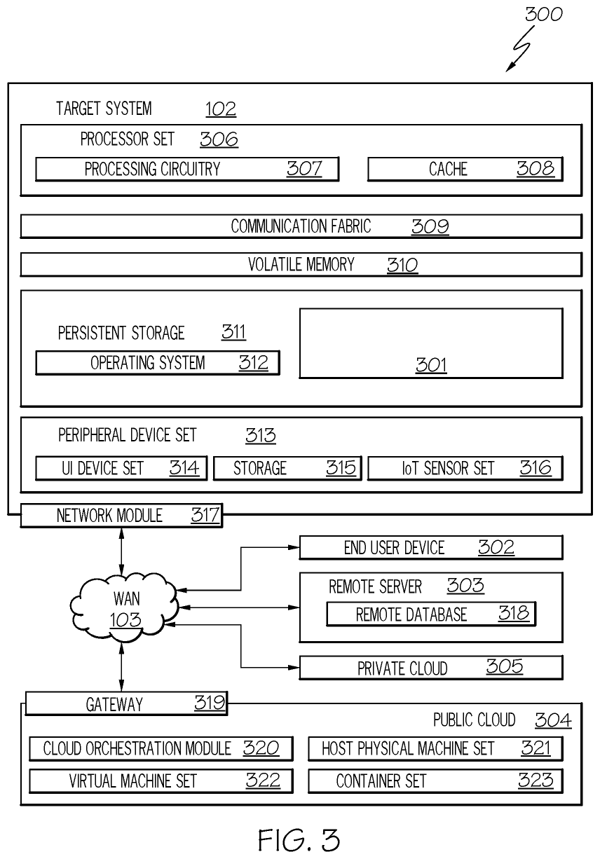

A description of the software components of target system 102 used for preserving concurrency and asynchronous execution for versioned documents is provided below in connection with FIG. 2. A description of the hardware configuration of target system 102 is provided further below in connection with FIG. 3.

System 100 is not to be limited in scope to any one particular network architecture. System 100 may include any number of client devices 101, target systems 102, blockchain networks 103 and storages 104, 105.

As stated above, FIG. 2 is a diagram of the software components of target system 102 used for preserving concurrency and asynchronous execution for versioned documents in accordance with an embodiment of the present disclosure.

Referring to FIG. 2, in conjunction with FIG. 1, target system 102 includes a generator 201 configured to generate a document instance identifier for a version of a versioned document. As previously discussed, the document instance identifier, as used herein, refers to a static identifier that uniquely identifies a document revision. Furthermore, the document instance identifier, as used herein, represents a specific state or instance of a versioned document that does not hold any relation to the logical order of this instance with respect to other versions of the versioned document.

In one embodiment, generator 201 generates a universally unique identifier (UUID) to correspond to the document instance identifier. A “universally unique identifier,” as used herein, is a 128 bit number, composed of 16 octets and represented as 32 base-16 characters. In one embodiment, generator 201 generates the UUID based on a timestamp and other factors, such as the network address, using an algorithm or tool, such as the Python® UUID module. In one embodiment, generator 201 generates the UUID by hashing both a namespace identifier and a name using a hashing algorithm, such as the message-digest algorithm 5 (MD5) or the secure hash algorithm 1 (SHA-1).

In one embodiment, generator 201 generates a pseudorandom number based on the state or instance of the versioned document as the document instance identifier that is assigned to the particular version of the versioned document. A pseudorandom number, as used herein, refers to a sequence of numbers whose properties approximate the properties of sequences of random numbers. The generated sequence is determined by an initial value (referred to as a seed) corresponding to the state or instance of the versioned document. The “state” of the versioned document, as used herein, refers to the stages of a document lifecycle, such as “checked out” (document is checked out to a user), “saved” (changes have been made to a check-out document which are saved to the database), “discarded check out” (all changes to the checked-out document are discarded), “check in” (edited document is checked in), “published” (document is published), etc. The “instance” of a document, as used herein, refers to a document that conforms to a classification or particular data type definition. In one embodiment, the seed may be determined based on the state or instance of the document based on performing a look-up in a data structure (e.g., table) that includes a listing of seeds along with the associated states or instances of a document. Upon identifying the state or instance of the document in the data structure, generator 201 then identifies the seed associated with the matched state or instance in the data structure. In one embodiment, such information is provided in the data structure by an expert. In one embodiment, such a data structure resides within a storage device (e.g., memory, disk drive) of target system 102.

In one embodiment, generator 201 utilizes various algorithms for generating such a pseudorandom number based on the seed, including, but not limited to, Square RNG, Philox, Threefry, Advanced Randomization System (ARS), Xorshift, etc.

In one embodiment, generator 201 generates a random number as the document instance identifier that is assigned to the particular version of the versioned document. In one embodiment, generator 201 utilizes various software tools for generating such a random number, including, but not limited to, randomizer, RNG, Watkins Random Number Generator, etc.

Furthermore, target system 102 includes a record creator 202 configured to create a document record for each versioned document uploaded to storage 105. As discussed above, a “document record,” as used herein, refers to a content file that has information pertaining to a versioned document that was uploaded to storage 105. For example, such a document record may include the document identifier, the document instance identifier, and/or the document issuance time.

The “document identifier,” as used herein, corresponds to a digit number (e.g., 6 digits) that uniquely identifies the versioned document in question. In one embodiment, such a document identifier is assigned to the versioned document by the application (e.g., word processing tool) used to create the versioned document. In one embodiment, client device 101 provides the document identifier to record creator 202 in connection with requesting the versioned document to be uploaded onto a platform, such as a blockchain platform.

As discussed above, the “document instance identifier,” as used herein, refers to a static identifier that uniquely identifies a document revision. In one embodiment, the document instance identifier is generated by generator 201, which is provided to record creator 202.

The “document issuance time,” as used herein, refers to a time at which a version of the versioned document came into existence. In one embodiment, the document issuance time is assigned to the versioned document by the application (e.g., word processing tool) used to create the versioned document. In one embodiment, client device 101 provides the document issuance time to record creator 202 in connection with requesting the versioned document to be uploaded onto a platform, such as a blockchain platform.

In one embodiment, the document version (referred to as the “floating version” or the “fluid version”) is determined at runtime (when requested) based on the document issuance time.

Furthermore, in one embodiment, the document record includes a hash value, which corresponds to a unique value that corresponds to the content of the versioned document. In one embodiment, such a hash value is generated by record creator 202 by obtaining a hash of the contents of the versioned document using a hash algorithm (e.g., MD5 (Message Digest 5) or SHA (Secure Hash Algorithm)).

Furthermore, in one embodiment, the document record includes a storage location, which corresponds to the location of the versioned document stored in storage 105, such as an object storage. In one embodiment, record creator 202 receives such a storage location from blockchain application 203 which stores the versioned document in storage 105 as discussed further below.

In one embodiment, record creator 202 stores the created document record in the distributed ledger of blockchain network 103.

Furthermore, as shown in FIG. 2, target system 102 includes a blockchain application 203 which corresponds to a decentralized application (or a distributed application) that is used for preserving concurrency and asynchronous execution of versioned documents.

In one embodiment, blockchain application 203 is configured to store the versioned document in storage 105 (e.g., object storage) as well as configured to provide the storage location to record creator 202 to be used in the created document record. In one embodiment, blockchain application 203 utilizes various software tools for storing the versioned document in storage 105 including, but not limited to, AWS® 53, StackPath®, NordLocker®, etc.

In one embodiment, blockchain application 203 is configured to generate a notification that the upload of the versioned document is complete, including pushing the notification to client device 101. In one embodiment, blockchain application 203 utilizes various software tools for generating and pushing such notifications including, but not limited to, Iterable®, Sailthru®, VWO® Engage, SendPulse®, CleverTap®, etc.

In one embodiment, blockchain application 203 is configured to fetch the document record of the versioned document from the distributed ledger of blockchain network 103 using various software tools including, but not limited to, BlocMonitor, Bloxy®, Bluzelle, VerifyChain, Voyager, etc.

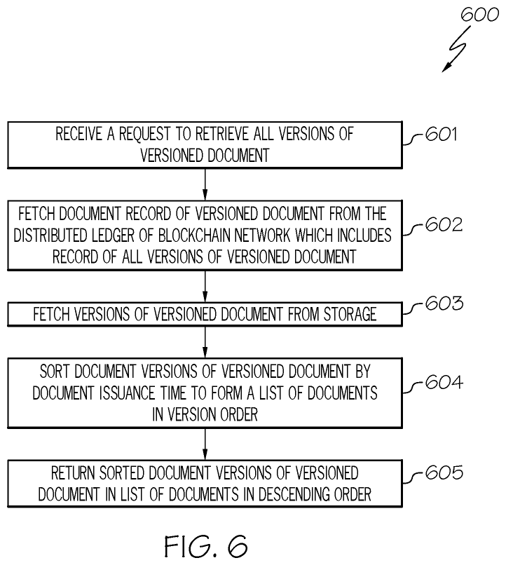

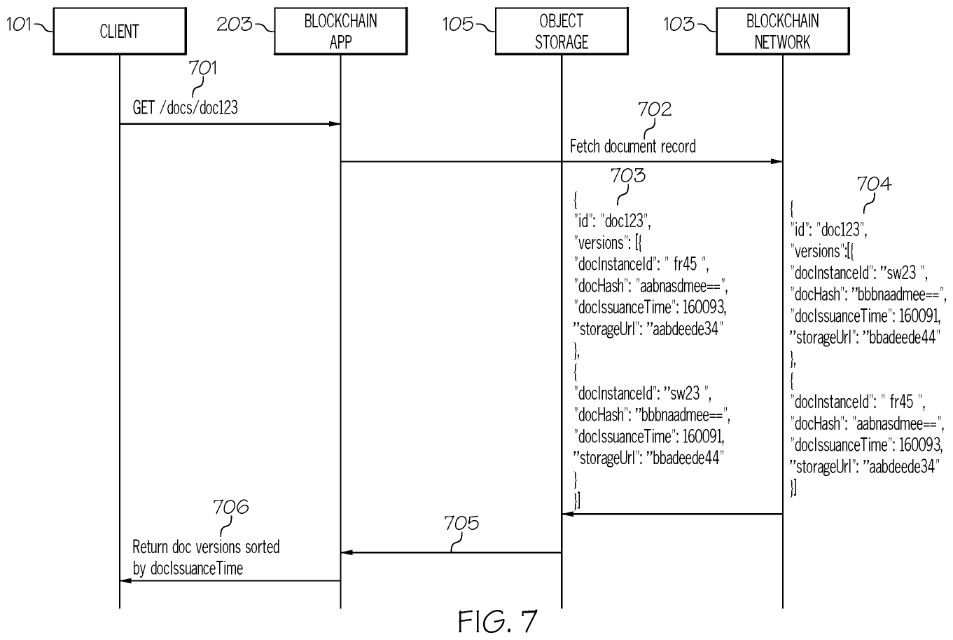

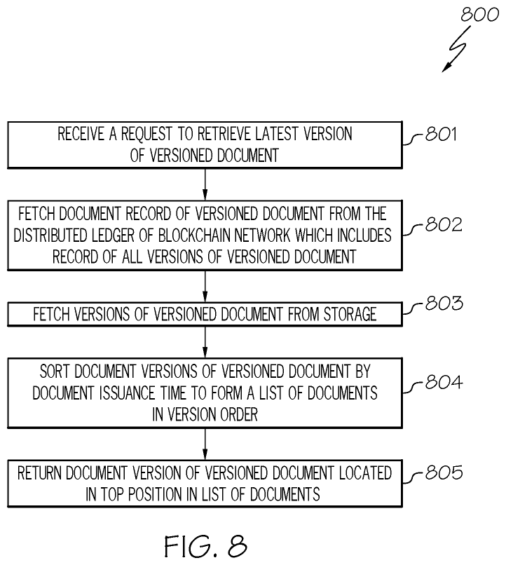

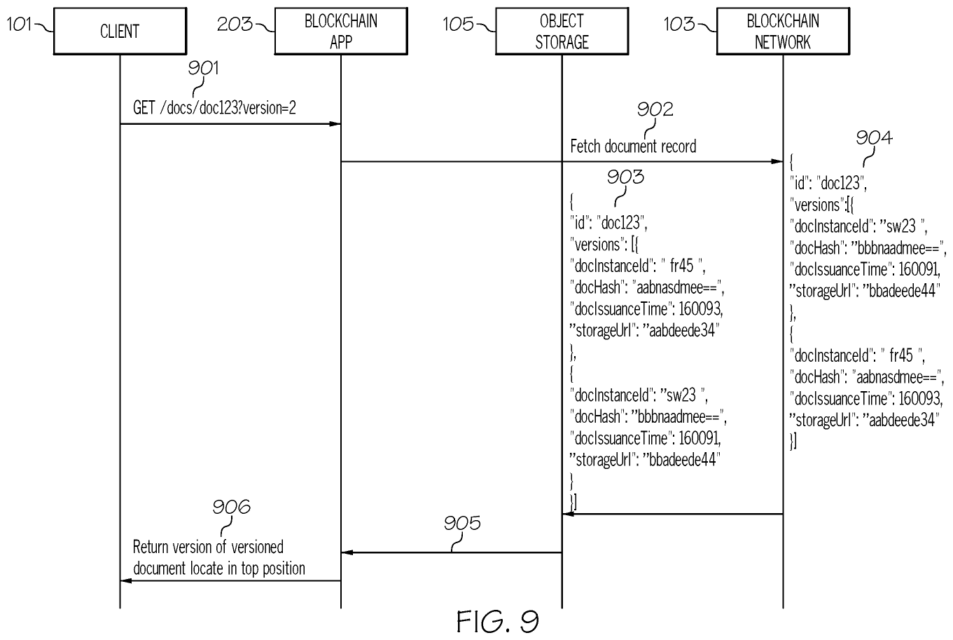

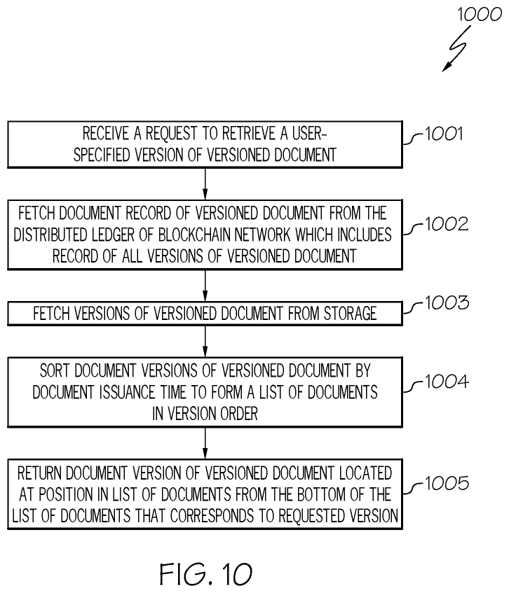

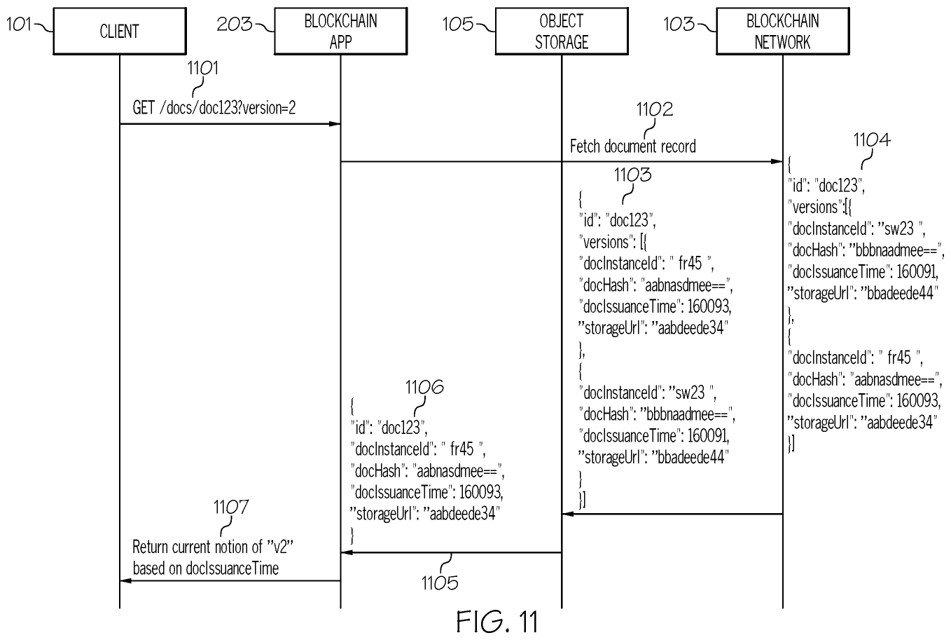

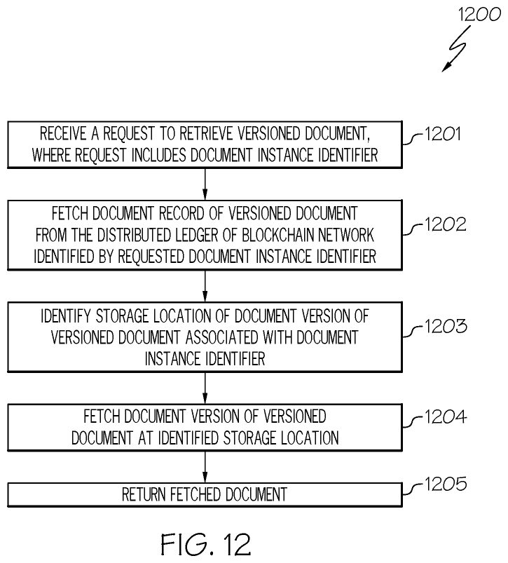

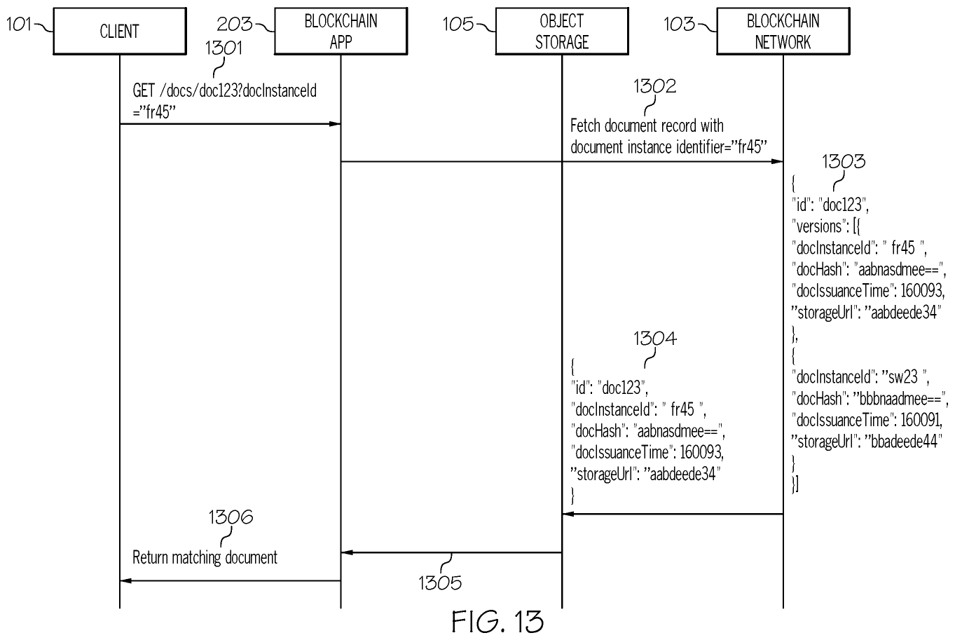

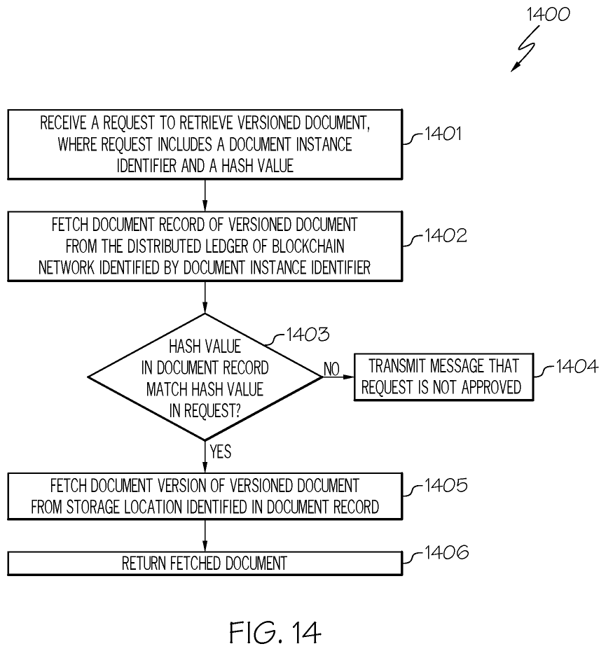

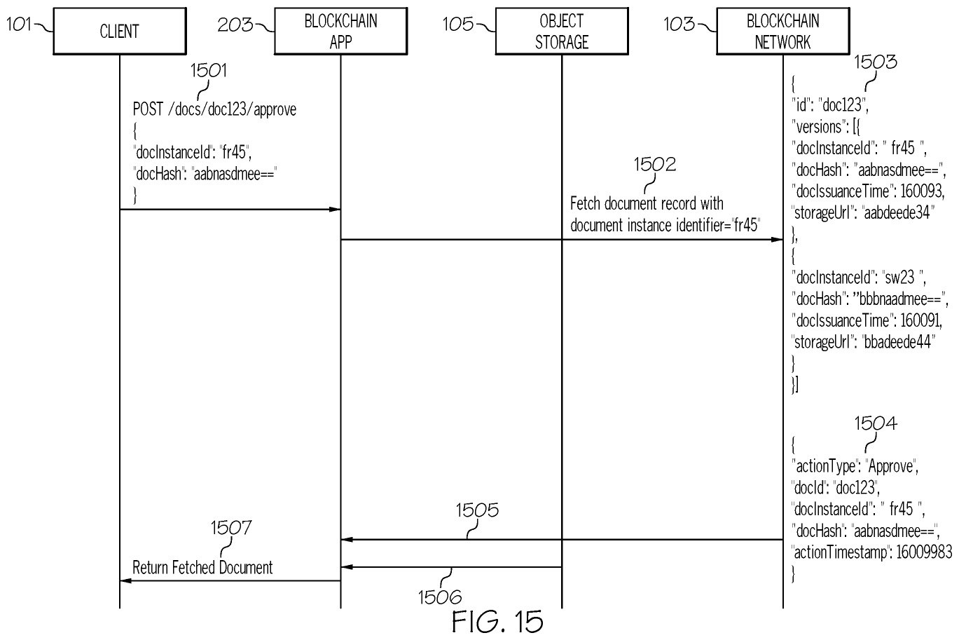

In one embodiment, blockchain application 203 is configured to handle various types of requests from the users of client devices 101 while still preserving concurrency and asynchronous execution for versioned documents, even after multiple versions of the versioned document have been uploaded simultaneously. Examples of such types of requests include a request to retrieve all versions of a versioned document, such as discussed below in connection with FIGS. 6-7, a request to retrieve the latest version of the versioned document as discussed below in connection with FIGS. 8-9, a request to retrieve a specific version of the versioned document as discussed below in connection with FIGS. 10-11, a request to retrieve a versioned document, where the request includes the document instance identifier, such as discussed below in connection with FIGS. 12-13, as well as a request to retrieve a versioned document, where the request includes the document instance identifier as well as a hash value, such as discussed below in connection with FIGS. 14-15.

In one embodiment, in connection with handling such types of requests, blockchain application 203 fetches the document record of the versioned document of the request from the distributed ledger of blockchain network 103 in response to: receiving a request to retrieve all versions of a versioned document, receiving a request to retrieve the latest version of the versioned document, receiving a request to retrieve a specific version of the versioned document, receiving a request to retrieve a versioned document, where the request includes the document instance identifier, and receiving a request to retrieve a versioned document, where the request includes the document instance identifier as well as a hash value.

In one embodiment, in connection with handling such types of requests, blockchain application 203 fetches the document versions of the versioned document from storage 105, such as an object storage. In one embodiment, blockchain application 203 utilizes various software tools for fetching the document versions of the versioned document from storage 105 including, but not limited to, AWS® 53, StackPath®, NordLocker®, etc.

In one embodiment, in connection with handling such types of requests, blockchain application 203 sorts the document versions of the versioned document by the document issuance time of the versioned document to form a list of documents in version order. In one embodiment, the document issuance time was identified from the document record of the versioned document. In one embodiment, blockchain application 203 utilizes various software tools for sorting the document versions of the versioned document including, but not limited to, DigitalDrawer, FileCenter, etc.

In one embodiment, in connection with handling such types of requests, blockchain application 203 returns the appropriate document version(s) of the versioned document to client device 101 as requested as discussed further below in connection with FIGS. 6-11. In one embodiment, in connection with handling such types of requests, blockchain application 203 returns the versioned document to client device 101 as requested, in which the request includes the document instance identifier, as discussed further below in connection with FIGS. 12-15.

A further description of these and other features is provided below in connection with the discussion of the method for preserving concurrency and asynchronous execution for versioned documents.

Prior to the discussion of the method for preserving concurrency and asynchronous execution for versioned documents, a description of the hardware configuration of target system 102 (FIG. 1) is provided below in connection with FIG. 3.

Referring now to FIG. 3, in conjunction with FIG. 1, FIG. 3 illustrates an embodiment of the present disclosure of the hardware configuration of target system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as preserving concurrency and asynchronous execution for versioned documents. In addition to block 301, computing environment 300 includes, for example, target system 102, network 103, such as a wide area network (WAN), end user device (EUD) 302, remote server 303, public cloud 304, and private cloud 305. In this embodiment, target system 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Target system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically target system 102, to keep the presentation as simple as possible. Target system 102 may be located in a cloud, even though it is not shown in a cloud in FIG. 3. On the other hand, target system 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto target system 102 to cause a series of operational steps to be performed by processor set 306 of target system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of target system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In target system 102, the volatile memory 310 is located in a single package and is internal to target system 102, but, alternatively or additionally, the volatile memory may be distributed over multiple packages and/or located externally with respect to target system 102.

Persistent Storage 311 is any form of non-volatile storage for computers that is now known or to be developed in the future. The non-volatility of this storage means that the stored data is maintained regardless of whether power is being supplied to target system 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of target system 102. Data communication connections between the peripheral devices and the other components of target system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where target system 102 is required to have a large amount of storage (for example, where target system 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows target system 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to target system 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates target system 102), and may take any of the forms discussed above in connection with target system 102. EUD 302 typically receives helpful and useful data from the operations of target system 102. For example, in a hypothetical case where target system 102 is designed to provide a recommendation to an end user, this recommendation would typically be communicated from network module 317 of target system 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to target system 102. Remote server 303 may be controlled and used by the same entity that operates target system 102. Remote server 303 represents the machine(s) that collect and store helpful and useful data for use by other computers, such as target system 102. For example, in a hypothetical case where target system 102 is designed and programmed to provide a recommendation based on historical data, then this historical data may be provided to target system 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to preserve concurrency and asynchronous execution for versioned documents. In one embodiment, such components may be implemented in hardware. The functions discussed above performed by such components are not generic computer functions. As a result, target system 102 is a particular machine that is the result of implementing specific, non-generic computer functions.

In one embodiment, the functionality of such software components of target system 102, including the functionality for preserving concurrency and asynchronous execution for versioned documents may be embodied in an application specific integrated circuit.

As stated above, versioned documents in a client system may need to be uploaded to a distributed application, such as a distributed application built and deployed on a blockchain platform, that supports asynchronous processing of these documents. A versioned document refers to a document with different versions of the same document. For example, such a document may have multiple versions, such as version 1, version 2 and version 3 of the same document. The client system may upload these documents concurrently, such as to the blockchain platform (target system) from a source system via a blockchain application programming interface (API). The target system then processes each upload request in an asynchronous manner. For example, when clients upload multiple versions of a document concurrently to the blockchain platform (target system) from a source system via a blockchain application programming interface (API), the document versions may become reversed between the source and target systems. For example, the document versions could arrive out of order at the blockchain or secure file transfer protocol (SFTP) location (in the case where the client uploads the documents to the SFTP location). Since the blockchain API processes these document versions in an asynchronous manner, the version ordering could be broken between the client and the blockchain platform. Furthermore, documents that fail in asynchronous processing are queued and retried. That is, a document version may be rejected resulting in the rejected document being queued and later retried. As a result, later versions of a document may appear as earlier versions on the blockchain platform if an earlier version of a document fails to be processed by the blockchain API. When the earlier version of the document is finally uploaded via a retry, the version of the document becomes the latest version of the document. As a result, the version ordering is broken between the client and the blockchain platform. Additionally, after uploading such versioned documents, the client may later request for a specific version of the versioned document, including requesting a logical order (e.g., version 1 followed by version 2, etc.) of the document versions if requesting more than one document version. Since the version ordering is broken between the client and the blockchain platform, the client may not be able to obtain the correct document version(s). Hence, there is not currently a means for preserving concurrency and asynchronous execution for versioned documents uploaded to distributed applications, such as in situations in which multiple versions of a versioned document are uploaded concurrently.

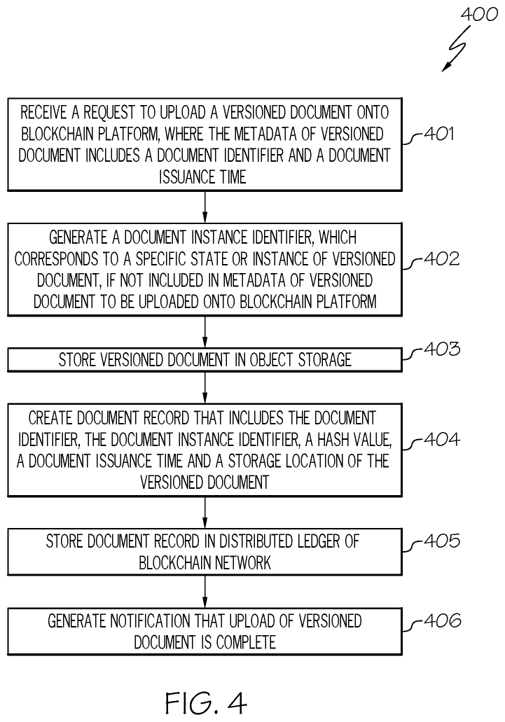

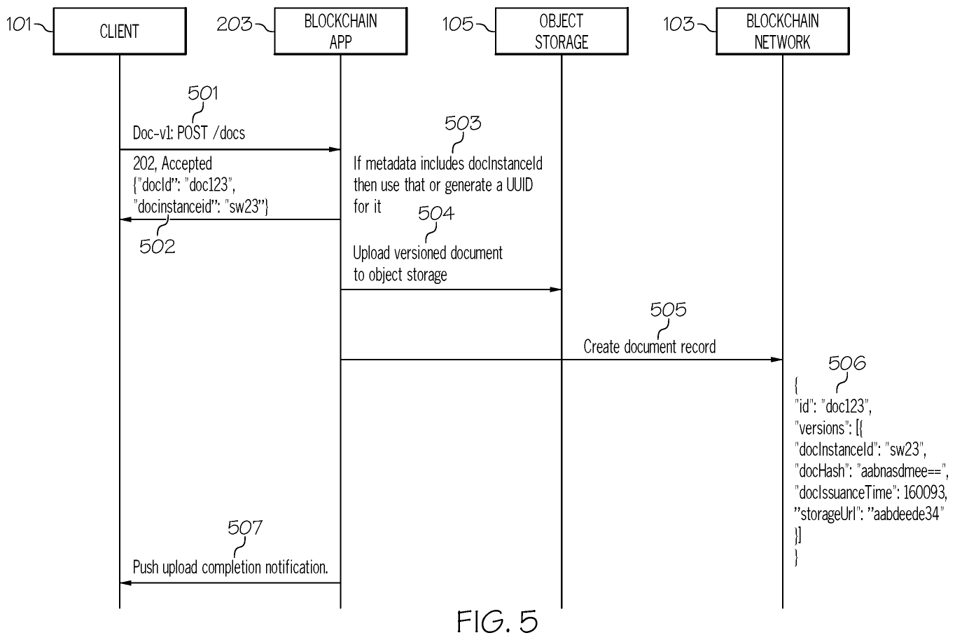

The embodiments of the present disclosure provide a means for preserving concurrency and asynchronous execution for versioned documents, such as in situations in which multiple versions of a versioned document are uploaded concurrently, as discussed below in connection with FIGS. 4-15. FIG. 4 is a flowchart of a method for uploading a document onto the blockchain platform. FIG. 5 illustrates uploading a document onto the blockchain platform using the steps described in FIG. 4. FIG. 6 is a flowchart of a method for handling a request to retrieve all versions of a versioned document. FIG. 7 illustrates handling a request to retrieve all versions of a versioned document using the steps described in FIG. 6. FIG. 8 is a flowchart of a method for handling a request to retrieve the latest version of a versioned document. FIG. 9 illustrates handling a request to retrieve the latest version of a versioned document using the steps described in FIG. 8. FIG. 10 is a flowchart of a method for handling a request to retrieve a user-specified version of a versioned document. FIG. 11 illustrates handling a request to retrieve a user-specified version of a versioned document using the steps described in FIG. 10. FIG. 12 is a flowchart of a method for handling a request to retrieve a versioned document, where the request includes the document instance identifier. FIG. 13 illustrates handling a request to retrieve a versioned document, where the request includes the document instance identifier, using the steps described in FIG. 12. FIG. 14 is a flowchart of a method for handling a request to retrieve a versioned document, where the request includes the document instance identifier and a hash value. FIG. 15 illustrates handling a request to retrieve a versioned document, where the request includes the document instance identifier and a hash value, using the steps described in FIG. 14.

As stated above, FIG. 4 is a flowchart of a method 400 for uploading a document onto the blockchain platform in accordance with an embodiment of the present disclosure. FIG. 5 illustrates uploading a document onto the blockchain platform using the steps described in FIG. 4 in accordance with an embodiment of the present disclosure.

Referring to FIG. 4, in conjunction with FIGS. 1-3 and 5, in step 401, blockchain application 203 of target system 102 receives a request to upload a versioned document onto a platform, such as a blockchain platform. For example, as shown in FIG. 5, blockchain application 203 of target system 102 receives a request 501 to upload a versioned document (“Doc-v1: POST/docs”) onto the blockchain platform.

In one embodiment, the metadata of the versioned document includes a document identifier and a document issuance time identifier.

As discussed above, the “document identifier,” as used herein, corresponds to a digit number (e.g., 6 digits) that uniquely identifies the document in question. The “document issuance time identifier,” as used herein, refers to a time at which a version of the versioned document came into existence.

Furthermore, as discussed above, in one embodiment, the metadata of the versioned document includes a document instance identifier.

A “document instance identifier,” as used herein, represents a specific state or instance of the document with no relation to a logical order of the instance of the versioned document with respect to other versions. Such an identifier is static and uniquely identifies a document revision.

Furthermore, as shown in FIG. 5, a notification 502 may be issued to client device 101 by blockchain application 203 indicating that the request has been accepted, where the notification includes the document identifier (“docid” corresponding to “doc123”) and the document instance identifier (“docinstanceid” corresponding to “sw23”).

In step 402, generator 201 of target system 102 generates a document instance identifier, which corresponds to a specific state or instance of the versioned document, if not included in the metadata of the versioned document to be uploaded onto the platform, such as a blockchain platform. For example, as shown in element 503 of FIG. 5, if the metadata of the versioned document includes the document instance identifier (“docinstanceid”), then it will later be used when the document record for the versioned document is created. Otherwise, generator 201 generates the document instance identifier, which may be a universally unique identifier (UUID), to be used when the document record for the versioned document is created.

As discussed above, in one embodiment, generator 201 generates a universally unique identifier (UUID) to correspond to the document instance identifier. A “universally unique identifier,” as used herein, is a 128 bit number, composed of 16 octets and represented as 32 base-16 characters. In one embodiment, generator 201 generates the UUID based on a timestamp and other factors, such as the network address, using an algorithm or tool, such as the Python® UUID module. In one embodiment, generator 201 generates the UUID by hashing both a namespace identifier and a name using a hashing algorithm, such as the message-digest algorithm 5 (MD5) or the secure hash algorithm 1 (SHA-1).

In one embodiment, generator 201 generates a pseudorandom number based on the state or instance of the versioned document as the document instance identifier that is assigned to the particular version of the versioned document. A pseudorandom number, as used herein, refers to a sequence of numbers whose properties approximate the properties of sequences of random numbers. The generated sequence is determined by an initial value (referred to as a seed) corresponding to the state or instance of the versioned document. The “state” of the versioned document, as used herein, refers to the stages of a document lifecycle, such as “checked out” (document is checked out to a user), “saved” (changes have been made to a check-out document which are saved to the database), “discarded check out” (all changes to the checked-out document are discarded), “check in” (edited document is checked in), “published” (document is published), etc. The “instance” of a document, as used herein, refers to a document that conforms to a classification or particular data type definition. In one embodiment, the seed may be determined based on the state or instance of the document based on performing a look-up in a data structure (e.g., table) that includes a listing of seeds along with the associated states or instances of a document. Upon identifying the state or instance of the document in the data structure, generator 201 then identifies the seed associated with the matched state or instance in the data structure. In one embodiment, such information is provided in the data structure by an expert. In one embodiment, such a data structure resides within a storage device (e.g., storage device 311, 315) of target system 102.

In one embodiment, generator 201 utilizes various algorithms for generating such a pseudorandom number based on the seed, including, but not limited to, Square RNG, Philox, Threefry, Advanced Randomization System (ARS), Xorshift, etc.

In one embodiment, generator 201 generates a random number as the document instance identifier that is assigned to the particular version of the versioned document. In one embodiment, generator 201 utilizes various software tools for generating such a random number, including, but not limited to, randomizer, RNG, Watkins Random Number Generator, etc.

In step 403, blockchain application 203 of target system 102 stores the versioned document in storage 105, such as an object storage. For example, as shown in element 504 of FIG. 5, blockchain application 203 uploads the versioned document to object storage 105.

As discussed above, in one embodiment, blockchain application 203 utilizes various software tools for storing the versioned document in storage 105 including, but not limited to, AWS® 53, StackPath®, NordLocker®, etc.

In step 404, record creator 202 of target system 102 creates a document record, as shown by element 505 of FIG. 5, for the uploaded versioned document that includes the document identifier, the document instance identifier, a hash value, a document issuance time and a storage location of the versioned document.

As discussed above, a “document record,” as used herein, refers to a content file that has information pertaining to a versioned document that was uploaded to database 105. For example, such a document record may include the document identifier, the document instance identifier, and the document issuance time.

As discussed above, the “document identifier” corresponds to a digit number (e.g., 6 digits) that uniquely identifies the versioned document in question. In one embodiment, such a document identifier is assigned to the versioned document by the application (e.g., word processing tool) used to create the document. In one embodiment, client device 101 provides the document identifier to record creator 202 in connection with requesting the versioned document to be uploaded onto a platform, such as a blockchain platform.

As also discussed above, the document instance identifier refers to a static identifier that uniquely identifies a document revision. In one embodiment, the document instance identifier is generated by generator 201, which is provided to record creator 202.

Furthermore, in one embodiment, the document record includes a hash value, which corresponds to a unique value that corresponds to the content of the versioned document. In one embodiment, such a hash value is generated by record creator 202 by obtaining a hash of the contents of the versioned document using a hash algorithm (e.g., MD5 (Message Digest 5) or SHA (Secure Hash Algorithm)).

The “document issuance time identifier” refers to a time at which a version of the versioned document came into existence. In one embodiment, the document issuance time is assigned to the versioned document by the application (e.g., word processing tool) used to create the versioned document. In one embodiment, client device 101 provides the document issuance time to record creator 202 in connection with requesting the versioned document to be uploaded onto a platform, such as a blockchain platform.

Furthermore, in one embodiment, the document record includes a storage location, which corresponds to the location of the versioned document stored in storage 105, such as an object storage. In one embodiment, record creator 202 receives such a storage location from blockchain application 203 which stores the versioned document in storage 105.

An example of such a document record that includes the information discussed above is shown in element 506 of FIG. 5. Referring to element 506, document record includes the document identifier (“id” corresponding to “doc123”), the document instance identifier (“docinsteanceid” corresponding to “sw23”), the hash value (“docHash” corresponding to “aabnasdmee==”), the document issuance time (“docIssuanceTime” corresponding to “160093”) and the storage location of the versioned document (“storageUrl” corresponding to “aabdeede34”).

In step 405, record creator 202 of target system 102 stores the created document record in the distributed ledger of blockchain network 103 as shown in FIG. 5.

In step 406, blockchain application 203 of target system 102 generates a notification 507 that the upload of the versioned document is complete, which is pushed to client device 101 as shown in FIG. 5.

As stated above, in one embodiment, blockchain application 203 utilizes various software tools for generating and pushing such notifications including, but not limited to, Iterable®, Sailthru®, VWO® Engage, SendPulse®, CleverTap®, etc.

Upon completing the upload of the versioned document to storage 105, blockchain application 203 handles various types of requests from the users of client devices 101 while still preserving concurrency and asynchronous execution for versioned documents, even after multiple versions of a document have been uploaded simultaneously, as discussed below in connection with FIGS. 6-15.

FIG. 6 is a flowchart of a method 600 for handling a request to retrieve all versions of a versioned document in accordance with an embodiment of the present disclosure. FIG. 7 illustrates handling a request to retrieve all versions of a versioned document using the steps described in FIG. 6 in accordance with an embodiment of the present disclosure.

Referring to FIG. 6, in conjunction with FIGS. 1-3 and 7, in step 601, blockchain application 203 of target system 102 receives a request 701 (“GET/docs/doc123”) to retrieve all versions of the versioned document.

In step 602, blockchain application 203 of target system 102 fetches the document record (see element 703 of FIG. 7) of versioned document as shown in element 702 of FIG. 7 from the distributed ledger of blockchain network 103 which includes a record of all the versions of the versioned document.

For example, as shown in FIG. 7, document record 703 includes a listing of the records for all versions, in which one of the versions has a document instance identifier (“docinstanceid”) corresponding to “sw23”, a document hash (“docHash”) corresponding to “bbbnaadmee==”, a document issuance time (“docIssuanceTime”) corresponding to 160091 and a storage location (“storage Url”) corresponding to “bbadeede44” while another version of the versioned document has a document instance identifier (“docinstanceid”) corresponding to “fr45”, a document hash (“docHash”) corresponding to “aabnasdmee==”, a document issuance time (“docIssuanceTime”) corresponding to 160093 and a storage location (“storage Url”) corresponding to “aabdeede34.”

As discussed above, in one embodiment, blockchain application 203 fetches the document record of the versioned document from the distributed ledger of blockchain network 103 using various software tools including, but not limited to, BlocMonitor, Bloxy®, Bluzelle, VerifyChain, Voyager, etc.

In step 603, blockchain application 203 of target system 102 fetches the versions of the versioned document from storage 105, such as an object storage.

As discussed above, in one embodiment, blockchain application 203 utilizes various software tools for fetching the document versions of the versioned document from storage 105 including, but not limited to, AWS® 53, StackPath®, NordLocker®, etc.

In step 604, blockchain application 203 of target system 102 sorts the document versions of the versioned document by the document issuance time to form a list of documents in version order.

For example, as shown in FIG. 7, document record 704 illustrates the document versions of the versioned document sorted by the document issuance time in which the version with the document instance identifier of “fr45” is now listed above the version with the document instance identifier of “sw23” since its document issuance time is 160093 which is after the document issuance time of 160091 for the version with the document instance identifier of “sw23.” Such a list of documents is then formed based on the sorted document versions of the versioned document as shown in document record 704.

As stated above, in one embodiment, blockchain application 203 utilizes various software tools for sorting the document versions of the versioned document including, but not limited to, DigitalDrawer, FileCenter, etc.

In step 605, blockchain application 203 of target system 102 returns the sorted document versions of the versioned document in the list of documents in descending order to client device 101 as shown by element 706 of FIG. 7.

For example, as shown in FIG. 7, in response to receiving the request to fetch all the document versions of the versioned document, blockchain application 203 fetches (see element 705) all the document versions of the versioned document from object storage 105 listed in record 704 in descending order. Blockchain application 203 would then first send the document version associated with the document issuance time of 160093 followed by sending the document version associated with the document issuance time of 160091.

By utilizing the document issuance time identifier, the requested document versions of the versioned document are able to be correctly provided to client device 101 when such document versions of the versioned document had been previously uploaded onto a platform (e.g., blockchain platform) via a distributed application.

Additionally, blockchain application 203 is configured to handle requests to retrieve the latest version of the versioned document as discussed below in connection with FIGS. 8-9.

FIG. 8 is a flowchart of a method 800 for handling a request to retrieve the latest version of a versioned document in accordance with an embodiment of the present disclosure. FIG. 9 illustrates handling a request to retrieve the latest version of a versioned document using the steps described in FIG. 8 in accordance with an embodiment of the present disclosure.

Referring to FIG. 8, in conjunction with FIGS. 1-3 and 9, in step 801, blockchain application 203 of target system 102 receives a request 901 (“GET/docs/doc123?version=latest”) to retrieve the latest version of the versioned document.

In step 802, blockchain application 203 of target system 102 fetches the document record (see element 903 of FIG. 9) of the versioned document as shown in element 902 of FIG. 9 from the distributed ledger of blockchain network 103 which includes a record of all the versions of the versioned document.

For example, as shown in FIG. 9, document record 903 includes a listing of the records for all versions, in which one of the versions has a document instance identifier (“docinstanceid”) corresponding to “sw23”, a document hash (“docHash”) corresponding to “bbbnaadmee==”, a document issuance time (“docIssuanceTime”) corresponding to 160091 and a storage location (“storage Url”) corresponding to “bbadeede44” while another version of the versioned document has a document instance identifier (“docinstanceid”) corresponding to “fr45”, a document hash (“docHash”) corresponding to “aabnasdmee==”, a document issuance time (“docIssuanceTime”) corresponding to 160093 and a storage location (“storage Url”) corresponding to “aabdeede34.”

As discussed above, in one embodiment, blockchain application 203 fetches the document record of the versioned document from the distributed ledger of blockchain network 103 using various software tools including, but not limited to, BlocMonitor, Bloxy®, Bluzelle, VerifyChain, Voyager, etc.

In step 803, blockchain application 203 of target system 102 fetches the versions of the versioned document from storage 105, such as an object storage.

As discussed above, in one embodiment, blockchain application 203 utilizes various software tools for fetching the document versions of the versioned document from storage 105 including, but not limited to, AWS® 53, StackPath®, NordLocker®, etc.

In step 804, blockchain application 203 of target system 102 sorts the document versions of the versioned document by the document issuance time to form a list of documents in version order.

For example, as shown in FIG. 9, document record 904 illustrates the document versions of the versioned document sorted by the document issuance time in which the version with the document instance identifier of “fr45” is now listed above the version with the document instance identifier of “sw23” since its document issuance time is 160093 which is after the document issuance time of 160091 for the version with the document instance identifier of “sw23.” Such a list of documents is then formed based on the sorted document versions of the versioned document as shown in document record 904.

As stated above, in one embodiment, blockchain application 203 utilizes various software tools for sorting the document versions of the versioned document including, but not limited to, DigitalDrawer, FileCenter, etc.

In step 805, blockchain application 203 of target system 102 returns the document version of the versioned document located in the top position in the list of documents to client device 101. For example, as shown in FIG. 9, in response to receiving the request to fetch the latest version of the versioned document, blockchain application 203 fetches (see element 905) the versioned document from object storage 105 corresponding to the versioned document (e.g., version of the document corresponding to the document instance identifier of “fr45”) listed in the top position in the list of documents as shown in record 904. For instance, blockchain application 203 fetches the versioned document associated with the document issuance time of 160093. Such a fetched version of the versioned document is then returned 906 to client device 101.

By utilizing the document issuance time identifier, the requested latest version of the versioned document is able to be correctly provided to client device 101 when such document versions of the versioned document had been previously uploaded onto a platform (e.g., blockchain platform) via a distributed application.

Furthermore, blockchain application 203 is configured to handle requests to retrieve a user-specified version of the versioned document as discussed below in connection with FIGS. 10-11.

FIG. 10 is a flowchart of a method for handling a request to retrieve a user-specified version of a versioned document in accordance with an embodiment of the present disclosure. FIG. 11 illustrates handling a request to retrieve a user-specified version of a versioned document using the steps described in FIG. 10 in accordance with an embodiment of the present disclosure.

Referring to FIG. 10, in conjunction with FIGS. 1-3 and 11, in step 1001, blockchain application 203 of target system 102 receives a request 1101 (“GET/docs/doc123?version=2”) to retrieve a user-specified version of the versioned document.

In step 1002, blockchain application 203 of target system 102 fetches the document record (see element 1103 of FIG. 11) of the versioned document as shown in element 1102 of FIG. 11 from the distributed ledger of blockchain network 103 which includes a record of all the versions of the versioned document.

For example, as shown in FIG. 11, document record 1103 includes a listing of the records for all versions, in which one of the versions has a document instance identifier (“docinstanceid”) corresponding to “sw23”, a document hash (“docHash”) corresponding to “bbbnaadmee==”, a document issuance time (“docIssuanceTime”) corresponding to 160091 and a storage location (“storage Url”) corresponding to “bbadeede44” while another version of the versioned document has a document instance identifier (“docinstanceid”) corresponding to “fr45”, a document hash (“docHash”) corresponding to “aabnasdmee==”, a document issuance time (“docIssuanceTime”) corresponding to 160093 and a storage location (“storage Url”) corresponding to “aabdeede34.”

As discussed above, in one embodiment, blockchain application 203 fetches the document record of the versioned document from the distributed ledger of blockchain network 103 using various software tools including, but not limited to, BlocMonitor, Bloxy®, Bluzelle, VerifyChain, Voyager, etc.

In step 1003, blockchain application 203 of target system 102 fetches the versions of the versioned document from storage 105, such as an object storage.

As discussed above, in one embodiment, blockchain application 203 utilizes various software tools for fetching the document versions of the versioned document from storage 105 including, but not limited to, AWS® 53, StackPath®, NordLocker®, etc.

In step 1004, blockchain application 203 of target system 102 sorts the document versions of the versioned document by the document issuance time to form a list of documents in the version order.

For example, as shown in FIG. 11, the document record 1104 illustrates the document versions of the versioned document sorted by the document issuance time in which the version with the document instance identifier of “fr45” is now listed above the version with the document instance identifier of “sw23” since its document issuance time is 160093 which is after the document issuance time of 160091 for the version with the document instance identifier of “sw23.” Such a list of documents is then formed based on the sorted document versions of the versioned document as shown in document record 1104.

As stated above, in one embodiment, blockchain application 203 utilizes various software tools for sorting the document versions of the versioned document including, but not limited to, DigitalDrawer, FileCenter, etc.

In step 1005, blockchain application 203 of target system 102 returns the document version of the versioned document located at the position in the list of document from the bottom of the list of documents that corresponds to the requested version. For example, as shown in FIG. 11, in response to receiving the request to fetch the 2n d version of the versioned document, blockchain application 203 fetches (see element 1105) the versioned document from object storage 105 corresponding to the versioned document (e.g., version of the document corresponding to the document instance identifier of “fr45”) listed in the 2n d position from the bottom of the list of documents as shown in record 1104. An illustration of the record of the fetched version of the versioned document is shown as element 1106 of FIG. 11. Such a fetched version of the versioned document is then returned 1107 to client device 101.

By utilizing the document issuance time identifier, the requested version of the versioned document is able to be correctly provided to client device 101 when such document versions of the versioned document had been previously uploaded onto a platform (e.g., blockchain platform) via a distributed application.

Additionally, blockchain application 203 is configured to retrieve a versioned document, where the request includes the document instance identifier, as discussed below in connection with FIGS. 12-13.

FIG. 12 is a flowchart of a method for handling a request to retrieve a versioned document, where the request includes the document instance identifier, in accordance with an embodiment of the present disclosure. FIG. 13 illustrates handling a request to retrieve a versioned document, where the request includes the document instance identifier, using the steps described in FIG. 12 in accordance with an embodiment of the present disclosure.

Referring to FIG. 12, in conjunction with FIGS. 1-3 and 13, in step 1201, blockchain application 203 of target system 102 receives a request 1301 (“GET/docs/doc123?docinstanceid=“fr45”) to retrieve a versioned document, where the request includes the document instance identifier.

In step 1202, blockchain application 203 of target system 102 fetches (see element 1302 of FIG. 13) the document record (see element 1303 of FIG. 13) of the versioned document from the distributed ledger of blockchain network 103 identified by the requested document instance identifier (“fr45”). As shown in FIG. 13, the document record of the versioned document as shown in element 1303 includes the record of the document version of the versioned document associated with the document instance identifier “fr45” as shown in document record 1304.

As discussed above, in one embodiment, blockchain application 203 fetches the document record from the distributed ledger of blockchain network 103 using various software tools including, but not limited to, BlocMonitor, Bloxy®, Bluzelle, VerifyChain, Voyager, etc.

In step 1203, blockchain application 203 of target system 102 identifies the storage location of the document version of the versioned document associated with the requested document instance identifier (e.g., “fr45”). For example, as shown in FIG. 13, the storage location of the version of the versioned document associated with the requested document instance identifier is “aabdeede34” as shown in record 1304.

In step 1204, blockchain application 203 of target system 102 fetches the document version of the versioned document from storage 105, such as an object storage, at the identified storage location.

For example, as shown in FIG. 13, blockchain application 203 of target system 102 fetches (see element 1305) the document version of the versioned document from storage 105, such as an object storage, at the identified storage location.

As discussed above, in one embodiment, blockchain application 203 utilizes various software tools for fetching the document versions of the versioned document from storage 105 including, but not limited to, AWS® 53, StackPath®, NordLocker®, etc.

In step 1205, blockchain application 203 of target system 102 returns the fetched document version of the versioned document to client device 101 that matches the document instance identifier provided by client device 101 as shown by element 1306 of FIG. 13.

By utilizing the document instance identifier, the requested versioned document is able to be correctly provided to client device 101 when such a versioned document had been previously uploaded onto a platform (e.g., blockchain platform) via a distributed application.

Furthermore, blockchain application 203 is configured to retrieve a versioned document, where the request includes the document instance identifier and a hash value, as discussed below in connection with FIGS. 14-15.

FIG. 14 is a flowchart of a method for handling a request to retrieve a versioned document, where the request includes the document instance identifier and a hash value, in accordance with an embodiment of the present disclosure. FIG. 15 illustrates handling a request to retrieve a versioned document, where the request includes the document instance identifier and a hash value, using the steps described in FIG. 14 in accordance with an embodiment of the present disclosure.

Referring to FIG. 14, in conjunction with FIGS. 1-3 and 15, in step 1401, blockchain application 203 of target system 102 receives a request 1501 (“POST/docs/doc123/approve {“docinstanceid”: “fr45”, “docHash”: “aabnasdmee==”}”) to retrieve a versioned document, where the request includes the document instance identifier and a hash value.

In step 1402, blockchain application 203 of target system 102 fetches (see element 1502 of FIG. 15) the document record (see element 1503 of FIG. 13) of the versioned document from the distributed ledger of blockchain network 103 identified by the requested document instance identifier (“fr45”). As shown in FIG. 15, the document record of the versioned document as shown in element 1503 includes the record of the document version of the versioned document associated with the document instance identifier “fr45.”

As discussed above, in one embodiment, blockchain application 203 fetches the document record from the distributed ledger of blockchain network 103 using various software tools including, but not limited to, BlocMonitor, Bloxy®, Bluzelle, VerifyChain, Voyager, etc.

In step 1403, blockchain application 203 of target system 102 determines whether the hash value in the document record matches the hash value in the request. In one embodiment, blockchain application 203 compares the hash value in the document record associated with the document instance identifier with the hash value in the request. For example, as shown in FIG. 15, the hash value in document record 1503 associated with the requested document instance identifier (“fr45”) is “aabnasdmee==.” Such a hash value is compared with respect to the hash value provided in the request (“aabnasdmee==”).

If such hash values do not match, then, in step 1404, blockchain application 203 of target system 102 transmits a message to client device 101 indicating that the request has not been approved. Such a request may be transmitted in any electronic form, including electronic mail.

If, however, such hash values do match, then, in step 1405, blockchain application 203 of target system 102 fetches the document version of the versioned document associated with the requested document instance identifier (“fr45”) at the storage location in storage 105 identified in the document record.

For example, as shown in FIG. 15, record 1504 indicates that such hash values match as indicated by the action type (“approve”), an indication of which may be obtained by blockchain application 203 (see element 1505). As shown in record 1503, the storage location of the document version of the versioned document associated with the requested document instance identifier (“fr45”) is “aabdeede34.” As a result, blockchain application 203 fetches the document version of the versioned document located at the storage location of “aabdeede34” from storage 105 as shown by element 1506 of FIG. 15.

In step 1406, blockchain application 203 of target system 102 returns the fetched document version of the versioned document to client device 101 as shown by element 1507 of FIG. 15.

By utilizing the document instance identifier and hash value, the requested versioned document is able to be correctly provided to client device 101 when such a versioned document had been previously uploaded onto a platform (e.g., blockchain platform) via a distributed application.

As a result of the foregoing, the principles of the present disclosure provide a means for preserving concurrency and asynchronous execution for versioned documents, such as in situations in which multiple versions of the versioned document are uploaded concurrently. The logical order is now decoupled from the state identified using the document instance identifier, which is static. Furthermore, the document instance identifier enables unique and deterministic identification of a particular document state (e.g., checked out). Additionally, document actions are recorded against the static document instance identifier rather than the document versions thereby preventing the breaking of the version ordering between the client and the blockchain platform. Furthermore, floating versions ensure an ordered view of the documents based on the document issuance time identifier. Hence, as a result of the usage of the document issuance time identifier and the static document issuance identifier, concurrency and asynchronous execution of the versioned documents are preserved.

Furthermore, the principles of the present disclosure improve the technology or technical field involving distributed applications. As discussed above, versioned documents in a client system may need to be uploaded to a distributed application, such as a distributed application built and deployed on a blockchain platform, that supports asynchronous processing of these documents. A versioned document refers to a document with different versions of the same document. For example, such a document may have multiple versions, such as version 1, version 2 and version 3 of the same document. The client system may upload these documents concurrently, such as to the blockchain platform (target system) from a source system via a blockchain application programming interface (API). The target system then processes each upload request in an asynchronous manner. For example, when clients upload multiple versions of a document concurrently to the blockchain platform (target system) from a source system via a blockchain application programming interface (API), the document versions may become reversed between the source and target systems. For example, the document versions could arrive out of order at the blockchain or secure file transfer protocol (SFTP) location (in the case where the client uploads the documents to the SFTP location). Since the blockchain API processes these document versions in an asynchronous manner, the version ordering could be broken between the client and the blockchain platform. Furthermore, documents that fail in asynchronous processing are queued and retried. That is, a document version may be rejected resulting in the rejected document being queued and later retried. As a result, later versions of a document may appear as earlier versions on the blockchain platform if an earlier version of a document fails to be processed by the blockchain API. When the earlier version of the document is finally uploaded via a retry, the version of the document becomes the latest version of the document. As a result, the version ordering is broken between the client and the blockchain platform. Additionally, after uploading such versioned documents, the client may later request for a specific version of the versioned document, including requesting a logical order (e.g., version 1 followed by version 2, etc.) of the document versions if requesting more than one document version. Since the version ordering is broken between the client and the blockchain platform, the client may not be able to obtain the correct document version(s). Hence, there is not currently a means for preserving concurrency and asynchronous execution for versioned documents uploaded to distributed applications, such as in situations in which multiple versions of a versioned document are uploaded concurrently.

Embodiments of the present disclosure improve such technology by receiving a versioned document to be uploaded onto a platform, such as a blockchain platform, where the metadata of the versioned document includes an identifier (“document issuance time identifier) representing a time at which the version of the versioned document came into existence. Furthermore, an identifier (“document instance identifier”) is generated in which the document instance identifier represents a specific state or instance of the versioned document with no relation to a logical order of the instance of the versioned document with respect to other versions of the versioned document. In one embodiment, the document instance identifier corresponds to a universally unique identifier (UUID), which is a 128 bit number, composed of 16 octets and represented as 32 base-16 characters. A document record may then be created for the versioned document which includes both the document issuance time identifier and the document instance identifier. Such a document record may be stored in the distributed ledger of the blockchain platform. Such identifiers may be utilized by a distributed application, such as a blockchain application, to handle various types of requests from the users of the client devices while still preserving concurrency and asynchronous execution for versioned documents, even after multiple versions of the versioned document have been uploaded simultaneously, such as requests to retrieve all versions of the versioned document, requests to retrieve the latest version of the versioned document, requests to retrieve a specific version of the versioned document, etc. Due to the utilization of such identifiers, the version ordering is not broken between the client device and the blockchain platform. Consequently, the client device will be able to obtain the correct document version(s). Furthermore, in this manner, there is an improvement in the technical field involving distributed applications.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for preserving concurrency and asynchronous execution for versioned documents, the method comprising:
receiving a versioned document to be uploaded onto a platform, wherein metadata of said versioned document comprises a first identifier representing a time at which a version of said versioned document came into existence;
generating a second identifier that represents a specific state or instance of said versioned document with no relation to a logical order of said instance of said versioned document with respect to other versions of said versioned document;
creating a document record comprising said first identifier and said second identifier; and
storing said document record in a distributed ledger of said platform.

2. The method as recited in claim 1 further comprising:
storing said versioned document in a storage without representing a logical order.

3. The method as recited in claim 1, wherein said platform is a blockchain platform.

4. The method as recited in claim 1 further comprising:
receiving a request to retrieve all document versions of said versioned document;
fetching a document record of said versioned document which includes records of all document versions of said versioned document, wherein each record for each document version of said versioned document is associated with a unique first identifier;
fetching said requested document versions of said versioned document;
sorting said document versions of said versioned document by said unique first identifiers to form a list of documents in version order; and
returning said sorted document versions of said versioned document in said list of documents in descending order.

5. The method as recited in claim 1 further comprising:
receiving a request to retrieve a latest document version of said versioned document;
fetching a document record of said versioned document which includes records of all document versions of said versioned document, wherein each record for each document version of said versioned document is associated with a unique first identifier;
fetching document versions of said versioned document;
sorting said document versions of said versioned document by said unique first identifiers to form a list of documents in version order; and
returning a first document located in a top position in said list of documents.

6. The method as recited in claim 1 further comprising:
receiving a request to retrieve a user-specified document version of said versioned document;
fetching a document record of said versioned document which includes records of all document versions of said versioned document, wherein each record for each document version of said versioned document is associated with a unique first identifier;
fetching document versions of said versioned document;
sorting said document versions of said versioned document by said unique first identifiers to form a list of documents in version order; and
returning a document located at a position in said list of documents from a bottom of said list of documents that corresponds to said user-specified version.

7. The method as recited in claim 1 further comprising:
receiving a request to retrieve said versioned document, wherein said request comprises said second identifier and a hash value;
fetching a document record of said versioned document identified by said second identifier, wherein said document record comprises a hash value;
comparing said hash value in said document record with said hash value associated with said request;
fetching said versioned document in response to said hash value in said document record matching said hash value associated with said request; and
returning said fetched versioned document.

8. A computer program product for preserving concurrency and asynchronous execution for versioned documents, the computer program product comprising one or more computer readable storage mediums having program code embodied therewith, the program code comprising programming instructions for:
receiving a versioned document to be uploaded onto a platform, wherein metadata of said versioned document comprises a first identifier representing a time at which a version of said versioned document came into existence;
generating a second identifier that represents a specific state or instance of said versioned document with no relation to a logical order of said instance of said versioned document with respect to other versions of said versioned document;
creating a document record comprising said first identifier and said second identifier; and
storing said document record in a distributed ledger of said platform.

9. The computer program product as recited in claim 8, wherein the program code further comprises the programming instructions for:
storing said versioned document in a storage without representing a logical order.

10. The computer program product as recited in claim 8, wherein said platform is a blockchain platform.

11. The computer program product as recited in claim 8, wherein the program code further comprises the programming instructions for:
receiving a request to retrieve all document versions of said versioned document;
fetching a document record of said versioned document which includes records of all document versions of said versioned document, wherein each record for each document version of said versioned document is associated with a unique first identifier;
fetching said requested document versions of said versioned document;
sorting said document versions of said versioned document by said unique first identifiers to form a list of documents in version order; and
returning said sorted document versions of said versioned document in said list of documents in descending order.

12. The computer program product as recited in claim 8, wherein the program code further comprises the programming instructions for:
receiving a request to retrieve a latest document version of said versioned document;
fetching a document record of said versioned document which includes records of all document versions of said versioned document, wherein each record for each document version of said versioned document is associated with a unique first identifier;
fetching document versions of said versioned document;
sorting said document versions of said versioned document by said unique first identifiers to form a list of documents in version order; and
returning a first document located in a top position in said list of documents.

13. The computer program product as recited in claim 8, wherein the program code further comprises the programming instructions for:
receiving a request to retrieve a user-specified document version of said versioned document;
fetching a document record of said versioned document which includes records of all document versions of said versioned document, wherein each record for each document version of said versioned document is associated with a unique first identifier;
fetching document versions of said versioned document;
sorting said document versions of said versioned document by said unique first identifiers to form a list of documents in version order; and
returning a document located at a position in said list of documents from a bottom of said list of documents that corresponds to said user-specified version.

14. The computer program product as recited in claim 8, wherein the program code further comprises the programming instructions for:
receiving a request to retrieve said versioned document, wherein said request comprises said second identifier and a hash value;
fetching a document record of said versioned document identified by said second identifier, wherein said document record comprises a hash value;
comparing said hash value in said document record with said hash value associated with said request;
fetching said versioned document in response to said hash value in said document record matching said hash value associated with said request; and
returning said fetched versioned document.

15. A system, comprising:
a memory for storing a computer program for preserving concurrency and asynchronous execution for versioned documents; and
a processor connected to said memory, wherein said processor is configured to execute program instructions of the computer program comprising:
receiving a versioned document to be uploaded onto a platform, wherein metadata of said versioned document comprises a first identifier representing a time at which a version of said versioned document came into existence;
generating a second identifier that represents a specific state or instance of said versioned document with no relation to a logical order of said instance of said versioned document with respect to other versions of said versioned document;
creating a document record comprising said first identifier and said second identifier; and
storing said document record in a distributed ledger of said platform.

16. The system as recited in claim 15, wherein the program instructions of the computer program further comprise:
storing said versioned document in a storage without representing a logical order.

17. The system as recited in claim 15, wherein said platform is a blockchain platform.

18. The system as recited in claim 15, wherein the program instructions of the computer program further comprise:
receiving a request to retrieve all document versions of said versioned document;
fetching a document record of said versioned document which includes records of all document versions of said versioned document, wherein each record for each document version of said versioned document is associated with a unique first identifier;
fetching said requested document versions of said versioned document;
sorting said document versions of said versioned document by said unique first identifiers to form a list of documents in version order; and
returning said sorted document versions of said versioned document in said list of documents in descending order.

19. The system as recited in claim 15, wherein the program instructions of the computer program further comprise:
receiving a request to retrieve a latest document version of said versioned document;
fetching a document record of said versioned document which includes records of all document versions of said versioned document, wherein each record for each document version of said versioned document is associated with a unique first identifier;
fetching document versions of said versioned document;
sorting said document versions of said versioned document by said unique first identifiers to form a list of documents in version order; and
returning a first document located in a top position in said list of documents.

20. The system as recited in claim 15, wherein the program instructions of the computer program further comprise:
receiving a request to retrieve a user-specified document version of said versioned document;
fetching a document record of said versioned document which includes records of all document versions of said versioned document, wherein each record for each document version of said versioned document is associated with a unique first identifier;
fetching document versions of said versioned document;
sorting said document versions of said versioned document by said unique first identifiers to form a list of documents in version order; and
returning a document located at a position in said list of documents from a bottom of said list of documents that corresponds to said user-specified version.
